(19) United States
(12) Patent Application Publication
(10) Pub. No.: US 2004/0118157 A1
(43) Pub. Date: Jun. 24, 2004

(54) Method for laser beam-assisted application of metal ions in glass for producing colorless and color pixels

(76) Inventors: Reinhard Borek, Halle/Saale (DE); Thomas Rainer, Wernigerode (DE); Klaus-Jurgen Berg, Halle/Saale (DE)

Correspondence Address: LERNER AND GREENBERG, PA, P O BOX 2480, HOLLYWOOD, FL, 33022-2480, US

(21) Appl. No.: 10/475,399

(22) PCT Filed: Apr. 18, 2002
(86) PCT No.: PCT/EP02/04284

(30) Foreign Application Priority Data
Apr. 19, 2001 (DE) 101 19 302.5

(51) Int. Cl. C03C 21/00

(52) U.S. Cl. 65/30.13

(57) ABSTRACT

The invention relates to a method for the laser-assisted introduction of metal ions by ion exchange and diffusion and for the colored internal scribing of glass.

With the aid of this method, it is possible for both colorless pixels with a different refractive index from their surroundings and colored pixels, for example in silver stain or copper ruby, to be produced in glass.

The processes which are required to produce the metal particles which cause the glass coloration, namely ion exchange and diffusion of metal ions into the glass, the reduction of these ions to form atoms and the aggregation of the atoms to form metal particles, take place in a locally delimited manner as a result of locally delimited heating. For this purpose, by way of example, a film which has been printed over its area with printable diffusion ink is stuck to the glass which is to be provided with a colored pattern, and the glass surface to which the film has been stuck is locally heated with focussed laser radiation. Metal particles are formed in the heated regions, and thereby colored pixels are formed in the glass without any damage or local melting of the glass.

The laser irradiation can also be controlled in such a way that only the ion exchange and the diffusion of the ions which have been introduced into the glass by this exchange take place in a locally limited manner and colorless pixels are formed.

The pixels can be used to mark, scribe and decorate glass and also to produce passive optical elements, for example transmission gratings.

The invention relates to a method for the laser-assisted introduction of metal ions through ion exchange and diffusion and for the coloring of glass (cf. for example /1/, /2/).

This method can be used to produce both colorless pixels with a different refractive index from their surroundings and colored pixels, for example in silver stain or copper ruby, in glass.

Hitherto, glass has generally been marked externally for labeling or advertising purposes. It is known that this is done by writing onto the surface of the glass or by machining the glass surface.

In this case, plastic films which have been precut as desired are usually adhesively bonded onto the glass surface; a further method for the external application of markings to glass surfaces is realized by screen printing. The films which have been stuck on, and also the screen print which has been applied, are subject to all external weathering influences and mechanical influences.

The known methods for marking glass surfaces by machining the glass surface include processes such as etching or engraving of the glass surfaces.

A drawback of these processes is the damage to the glass surfaces.

Therefore, work has long been ongoing on laser-assisted methods for the internal marking of glass.

With these known internal marking methods, it is possible to produce colored marks, for example in silver stain or copper ruby, in glass.

A method of this type has been described, for example, in DD 215 776, “Verfahren zur Herstellung farbiger Bilder auf Glas” [Process for producing colored images on glass]. According to this method, the glass surface, which has been covered with a diffusion ink, is locally melted by means of infrared laser radiation, and in the process the diffusion ink is mixed into the molten regions of glass by convection. For as long as the glass is sufficiently warm, color ions diffuse out of the diffusion ink which has been mixed in into the surrounding glass “. . . so that they leave behind a color trace which is permanent and uniform to the naked eye . . . ”.

Drawbacks of this method include the stresses which always remain in glass in the region of the color traces after local melting, and in particular the convex curvature of the glass surface in the region of the laser track which is also always associated with surface melting; these drawbacks crucially restrict the possible uses of the glass.

According to further known methods, two method steps are always carried out in succession.

In a first method step, Ag⁺ and/or Cu⁺ ions are introduced into the glass by ion exchange between a molten salt and the glass surface. The ion exchange alone does not effect any coloration in the glass. The second step of this method involves heating the glass or certain partial areas thereof by absorption of the laser radiation focussed onto the glass surface, and in this way Ag⁺ and/or Cu⁺ ions are reduced to form atoms by reducing agents which are inherent to the glass, and these atoms are then aggregated to form metal particles which are responsible for the coloration of the glass.

On account of the advantageous properties which are typical for the material-treatment to the laser, such as versatility and speed, the second process step of the solutions which form the prior art can be carried out with little outlay and can very readily be integrated in production processes. On the other hand, the first method step, that of ion exchange, is much more difficult to realize, on account of the complicated technology and the significantly longer process times compared to the second process step. Moreover, this second method step can only be integrated in production processes with difficulty. The technological outlay entailed by large industrial-scale ion exchange installation is very high, since there are high quality demands with regard to the homogeneity of the molten salt and of the temperature field.

Moreover, with this type of ion exchange, it is not possible for the metal ions which are required to be introduced only into the partial regions which are to be colored. Since in typical applications these partial regions are small compared to the overall surface area of the glasses, this restriction often constitutes a considerable economic drawback.

A further method for producing marks, writing and decoration directly below the glass surface by means of diffusion inks is the use of films, which are printed with diffusion ink in the form of written characters, symbols or images and are stuck to the glass which is to be marked in the same way as transfers.

The films which have been printed in this way are therefore also known as transfers. The technical information document /3/describes diffusion inks and transfers: “Diffusion inks—also known as silver stains—are silver-containing preparations which impart a yellow to dark-brown transparent coloration to the decorated glass . . . diffusion inks can . . . be transferred to the object which is to be decorated by means of a transfer.” A further product example is TRANSCOLOR transfers produced by H. Albert OHG /4/.

After the [lacuna] have been stuck on, the glasses are heated to temperatures of up to the transformation temperature T_{g} of the glass, in order to effect diffusion of the metal ions into the glass, subsequent reduction of these ions to form atoms and finally the aggregation of the atoms to form coloring metal particles and thereby to effect the formation of the marks or decorations in the glass.

To produce strong colors, the heat-treatment process has to be carried out over several hours.

A considerable drawback of this heat treatment process, in addition to the long process times, is the fact that all the glass is heated to temperatures at which it can become so soft as to lose its shape.

To prevent this from happening, the heat treatment process is often divided into a plurality of shorter, successive heat treatment steps separated by cooling of the glass.

On account of diffusion processes during the heat treatment and technological restrictions of the printing process, this marking process is only able to achieve lower resolutions of the markings or decorations compared to the resolutions which can be achieved with laser-assisted internal marking.

A further drawback of the known methods using films which are to be stuck on consists in the fact that the shape and size of the film predetermines the image which is to be produced and it is also not possible to produce different color intensities.

The method of laser-assisted colored internal marking and the method of heat treatment of glasses to which transfers have been stuck differ in terms of the basic method steps of ion exchange, reduction of the metal ions and formation of the metal particles, including the required local heating of the glass.

In the first method, what is known as low-temperature ion exchange takes place globally in a first, global heating step to temperatures which are well below the transformation temperature T_{g} of the glass, and locally delimited reduction of the metal ions and formation of the metal particles take place in a second, likewise locally delimited heating step.

In the method involving heat treatment of glasses to which transfers have been stuck, ion exchange, reduction of the metal ions and formation of the metal particles as a function of the shape and size of the film which has been stuck on take place in locally delimited fashion within one global heating step to temperatures of up to the transformation temperature T_{g} of the glass.

The invention is based on the object of developing a method for the laser-assisted introduction of metal ions and for the colored internal marking of glass which avoids the drawbacks of the prior art.

This object is achieved by the invention in accordance with patent claims 1 to 14 by virtue of the fact that, in a single local heating step, ion exchange, diffusion or ion exchange and diffusion, reduction of the metal ions and formation of the metal particles take place in a locally delimited manner in the focus of a laser beam within industrially relevant, short times, resulting in the production of a colorless or colored pixel.

This can advantageously be realized by the use of films which are printed with diffusion ink on their surface and are stuck to the glass which is to be marked in the same way as transfers, by virtue of the fact that locally delimited heating of the surface of a glass to which a transfer has been stuck, by means of focussed laser radiation, makes it possible to produce pixels within very short times and without the glass being damaged and partially melted.

One particular configuration of the method according to the invention consists in the fact that the local heating of the glass by by means of [sic] laser radiation focussed onto the glass surface is guided in such a way that only ion exchange and diffusion, without subsequent reduction of the metal ions and their aggregation to form metal particles, take place.

This allows the production of glasses with colorless pixels which contain an increased amount of, for example, Ag⁺ and/or Cu⁺ ions compared to their surroundings. The metal ions which have been introduced impart an increased refractive index to the pixel. This change in refractive index can only be rendered visible with the aid of optical equipment, for example a phase contrast microscope. This possibility of invisible writing or marking of glass can only be realized by using the method according to the invention.

Furthermore, by changing the intensity profile of the laser beam, it is possible to influence the radial concentration profile of the metal ions which have been introduced by ion exchange and therefore the radial refractive index profile in the irradiated region of the glass. A very specific radial refractive index profile has to be present, for example, if a region of the glass is to act as a gradient index lens, also known as a grin lens.

The fact that ion exchange, reduction of the metal ions and their aggregation to form metal particles take place in unusually short times in the locally heated regions is all the more striking if one takes into account the long process times involved in the use of the transfers which has hitherto been customary.

Moreover, the marking method according to the invention avoids the disadvantageous global heating of the glass. The avoidance of any global heating processes with the new method results in a considerable energy saving compared to the other two marking methods.

The novel method is distinguished by simple technological feasibility and the fact that it can be very successfully integrated into production processes. Its high flexibility is characterized by the fact that any desired, frequently changing electronic written and image patterns can be reproduced as a result of the computer control of the laser beam.

The surface of the glass which is to be provided with a colored internal marking can alternatively have staining pastes or diffusion inks applied to it without the use of transfers, by means of standard methods such as painting or spraying.

A further variant of the marking method consists in the fact that a plurality of successive marking operations take place, in which transfers which have had staining pastes or diffusion inks which contain different metal ions printed onto their surface, are stuck to the glass surface. In this way, it is possible to produce multicolored markings or decorations.

The novel marking method can advantageously be realized using CO₂ laser radiation. When using this CO₂ laser radiation, the pixels can have a minimum diameter of around 100 μm and a depth of less than 1 μm directly below the glass surface. Electronic written and image patterns can be reproduced with high resolutions in the glass. Since the pixels are located inside the glass, writing or markings produced in this way are completely scratch-resistant, are just as chemically resistant as the glass itself and are thermally stable up to temperatures just below the transformation temperature T_{g} of the glass. Moreover, the writing or markings are resistant to UV radiation.

The method according to the invention advantageously does not cause any damage to or local melting of the glass.

The inventive solution is to be explained in more detail below with reference to an exemplary embodiment.

A film which does not determine the shape and/or size of the image and has had the diffusion ink TRANSCOLOR RUBIN AMBER 2000 printed onto its surface, is adhesively bonded onto commercially available float glass. This diffusion ink effects coloration of the [lacuna] induced by silver particles.

The glass surface to which the film has been stuck is heated in punctiform fashion using a focussed CO₂ laser beam.

The laser beam-induced heating is carried out in accordance with a predetermined pattern, which is stored as a black-and-white bitmap file in a resolution of 600 dpi.

The pattern is produced in the glass surface in lines by computer-controlled guidance of the laser beam by means of a commercially available laser scanner over the glass surface, by virtue of the fact that local heating of the glass surface takes place in each case at the pattern dots which are marked in black.

To introduce metal ions, the laser-assisted local heating of these dots is carried out in such a way that only the diffusion of silver ions into the glass is induced, and colorless pixels are produced at those locations in the glass.

After the laser irradiation, the film residues are removed from the glass surface. As a result of the treatment, the glass now contains the pattern in its surface, in a resolution of 600 dpi, but this pattern can only be seen using optical equipment.

It was possible to successfully produce invisible markings with laser powers of less than 10 watts.

To realize colored internal marking, the local heating of the dots of the pattern on the film marked in black is carried out in such a way that the formation of silver particles is induced in the glass and at these locations the glass is colored yellow to brown.

As a result of the treatment, the glass now contains the pattern in its surface in a resolution of 600 dpi. It has been possible to successfully produce coloration with laser powers of less than 20 watts.

/1/T. Rainer, K.-J. Berg, G. Berg, “Farbige Innenbeschriftung von Floatglas durch CO₂-Laserbestrahlung Kurzreferate (Vorträge) der 73. Glastechnischen Tagung Halle (Saale), [Colored internal marking of float glass by CO₂ laser irradiation, short papers (presentations) from the 73rd Glass Industry Conference Hall], Deutsche Glastechnische Gesellschaft (DGG), pp. 127-130

/2/T. Rainer. “Wird Fensterglas zum High-Tech-Material? Kleine Teilchen, groβe Wirkung” [Will window glass become a high-tech material? small particles, high action], Glaswelt 6/2000, pp. 46-51

/3/Technical Information—No. 3.22/Rev.2/Nov. 3, 1998, Heraeus, www.heraeus.de

/4/e.g. TRANSCOLOR Transfers produced by H. Alberth OHG, Transfertechnik, Elpersheim

1. A method for the laser-assisted introduction of metal ions into and for the production of colored pixels in glass without any melting of or damage to the glass, characterized in that for the laser-assisted introduction of metal ions, the ion exchange between a donor medium for suitable metal ions and a glass surface which is in contact therewith and the diffusion of suitable ions into the glass take place in a manner which is locally limited to the focal area of the laser radiation focussed onto the glass surface at temperatures below the softening point of the glass within less than one second, and in that to produce colored pixels in the glass, the processes in addition to ion exchange and diffusion which are required to produce the metal particles causing the coloration, namely reduction of the ions which have diffused in to form atoms and aggregation of the atoms to form metal particles take place simultaneously therewith, at temperatures which are higher than those required for ion exchange and the diffusion and are below the softening point of the glass, within less than one second.

2. The method as claimed in claim 1, characterized in that the glass surface which is in contact with a donor medium for suitable metal ions is heated in punctiform fashion by a focussed laser beam which is moved at a defined speed relative to the glass surface, and in the process the heating induced by the laser beam follows a stipulated pattern which is stored as a file of a defined resolution as a control file for the laser control, and in the process the pattern is produced in the glass surface by computer-controlled guidance of the laser beam over the glass surface in accordance with the predetermined control file.
